(19) United States
(12) Patent Application Publication
(10) Pub. No.: US 2005/0214439 A1
(43) Pub. Date: Sep. 29, 2005

(54) Methods for enhancing soy-containing foods and foods made thereby

(76) Inventors: Yael Vodovotz, Hilliard, OH (US); Steven Schwartz, Powell, OH (US); Yu Chu Zhang, Columbus, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/809,232

(22) Filed: Mar. 25, 2004

(51) Int. Cl. A23L 1/164

(52) U.S. Cl. 426/634

(57) ABSTRACT

Methods of increasing the isoflavone aglycone concentration in a soy-containing comestible comprising maintaining the comestible in a temperature of from about 20° C. to about 70° C., for a period of from about 1 minute to about four hours, wherein the method results in an increase in isoflavone aglycone concentration. In some instances, additional β-glucosidase can be added, and in some instances, additional processing steps, such as baking, can be included.

### FIELD OF THE INVENTION

The present invention relates to methods for modifying the isoflavone distribution in soy-based foods, and in particular, soy breads. The invention relates to steps taken during food processing, including holding a comestible at a desired temperature for a desired time, and adding enzyme-rich ingredients, to achieve a desired effect. The invention also relates to comestibles formed using the inventive methods.

### BACKGROUND OF THE INVENTION

Isoflavones in soy are found either as aglycones or their conjugates (malonyl-β-glucosides, acetyl-β-glucosides, and β-glucosides) with glycosidic conjugates being the predominant forms in unprocessed soybeans. The bioavailability and biological activity of soy isoflavones is highly dependent on the chemical structures of these compounds. Recent clinical studies observed that isoflavone aglycones were absorbed faster and in greater amounts than their glycosylated forms (Izumi et al. 2000). An increased level of isoflavone aglycones in soy foods may improve the absorption of isoflavones following soy food ingestion (Pandjaitan et al. 2000).

### SUMMARY OF THE INVENTION

Features and Advantages of the Invention

The present invention is advantageous in providing, among other things, methods for increasing the isoflavone aglycone content of soy-containing foods by adding ingredients that are both natural and pleasing to the palate, and by using processing methods that even further increase the aglycone content.

The present invention also provides improved soy-containing food products that exhibit high concentrations of isoflavone aglycones and that are superior in flavor to other comparable products.

Additional features and advantages of the invention will be set forth in part in the description that follows, and in part will be obvious from the description, or may be learned by practice of the invention. The features and advantages of the invention will be realized and attained by means of the elements and combinations particularly pointed out in the appended claims.

### SUMMARY OF THE INVENTION

Features and advantages of this invention are achieved by, among other things, methods of increasing the isoflavone aglycone concentration in a soy-containing comestible, which methods include maintaining the comestible in a temperature of from about 20° C. to about 70° C., for a period of from about 1 minute to about four hours, wherein the method results in an increase in isoflavone aglycone concentration. The temperature can be from about 30° C. to about 60° C., or from about 40° C. to about 50° C., or from about 45° C. to about 48° C. The period can range from about 1 to about 3 hours, or can be about 2 hours.

In some embodiments, the methods further include adding at least one β-glucosidase-containing composition before maintaining the comestible in a temperature of from about 20° C. to about 70° C., for a period of from about 1 minute to about four hours. The β-glucosidase-containing composition can include almond, and the almond may be raw almond. Following addition of enzyme, the methods may additionally include heating the comestible in a temperature of from about 120° C. to about 260° C., for a period of from about 15 minutes to about 2 hours, after maintaining the comestible in a temperature of from about 22° C. to about 70° C., for a period of from about 30 minutes to about four hours. The heating temperature can range from about 150° C. to about 180° C., or from about 160° C. to about 165° C.

The methods also include the step of heating the comestible in a temperature of from about 120° C. to about 260° C., for a period of from about 15 minutes to about 2 hours, after maintaining the comestible in a temperature of from about 22° C. to about 70° C., for a period of from about 30 minutes to about four hours, without the additional step of adding an enzyme-containing component. The heating temperature can range from about 175° C. to about 225° C., or from about 190° C. to about 210° C.

The invention also provides comestibles having a β-glucosidase activity of greater than or equal to about 35 U when measured by assaying its rate of hydrolysis of p-nitrophenyl-β-D-glucopyranoside at a temperature of 37° C. for 30 minutes at pH 4.6, wherein the comestible includes from about 1% to about 75% by total weight, of almond. The β-glucosidase activity can greater than or equal to about 40 U, 45 U, or greater than or equal to about 50 U. In some embodiments, the comestible has at least about 5% by total weight, of soy-based ingredients. The comestible can have greater than or equal to about 4, 5, 6, or 7 g of soy protein per serving. The comestible can have greater than or equal to about 300, 400, or 500 nmol/g of isoflavone aglycones. The comestible can have from about 1% to about 15%, or about 2.5% to about 10%, or about 5% to about 8% by total weight, almond.

The invention also provides soy bread products having greater than or equal to about 6.25 g soy protein per serving, from about 2% to about 10% by total weight, of almond, and greater than or equal to about 200 nmol/g of isoflavone aglycones. The soy bread product can include from about 5% to about 8% almond and greater than or equal to about 400 nmol/g of isoflavone aglycones. The almond can be, for example, chopped almond, ground almond, or almond powder. The almond can exhibit an average particle size of less than or equal to about 1 mm or less than or equal to about 0.1 mm.

The invention also provides soy bread products enriched in isoflavone aglycones, comprising greater than about 2.5%, by total weight, of almond. The soy bread product can have a greater concentration of isoflavone aglycones than isoflavone glucosides.

It is to be understood that both the foregoing general description and the following detailed description are exemplary and explanatory only and are not restrictive of the invention, as claimed.

The accompanying drawings, which are incorporated in and constitute a part of this specification, may illustrate embodiments of the invention, and together with the description, serve to explain the principles of the invention.

### BRIEF DESCRIPTION OF THE DRAWINGS

FIG. 1 shows changes in isoflavones and β-glucosidase activity during proofing at 22° C. for 1, 2, 3, and 4 hours. Solid lines correspond to the isoflavone content in soy bread doughs. Dotted lines correspond to the relative β-glucosidase activity in these doughs. Values are means±SD of three independent determinations.

FIG. 2 shows changes in isoflavones and β-glucosidase activity during proofing at 32° C. for 1, 2, 3, and 4 hours. Solid lines correspond to the isoflavone content in soy bread doughs. Dotted lines correspond to the relative β-glucosidase activity in these doughs. Values are means±SD of three independent determinations.

FIG. 3 shows changes in isoflavones and β-glucosidase activity during proofing at 48° C. for 1, 2, 3, and 4 hours. Solid lines correspond to the isoflavone content in soy bread doughs. Dotted lines correspond to the relative β-glucosidase activity in these doughs. Values are means±SD of three independent determinations.

FIG. 4 shows increase in isoflavone aglycones in soy bread during proofing at 22, 32, and 48° C. for 1, 2, 3 and 4 hours. Values are means±SD of three independent determinations.

FIG. 5 diagrammatically illustrates the experimental design for Example 2.

FIG. 6 shows the gradient separation using reverse phase HPLC (see conditions in text) of twelve soy isoflavones from soy ingredients and bread samples. Elution: 1. daidzin, 2. glycitin, 3. genistin, 4. malonyldaidzin, 5. malonylglycitin, 6. acetyidaidzin, 7. acetylglycitin, 8. malonylgenistin, 9. daidzein, 10. glycitein, 11. acetylgenistin, 12. genistein.

FIG. 7 shows the change in isoflavone distribution during bread making of soy dough mix, proofed dough and baked dough. An asterisk indicates significantly different (p<0.05, ANOVA).

FIG. 8 shows changes in isoflavone distribution during proofing from 04 hours. The data were analyzed statistically by MANOVA and ANOVA using STATVIEW™ (BrainPower Inc., Calabasa, Calif.). A P value of 0.05 was considered significant (*).

FIG. 9 shows plots of β-glucosidase activity with changes in isoflavone β-glucosides (A) and isoflavone aglycones (B) and the correlation between changes in isoflavone β-glucosides and isoflavone aglycones (C) during extended proofing.

FIG. 10 shows the changes in isoflavones during baking after prolonged proofing for 1, 2, 3, and 4 hours. (□: before baking, ▪: after baking. A: baked after proofing for one hour. B: baked after proofing for two hours. C: baked after proofing for three hours. D: baked after proofing for four hours.)

FIG. 11 shows changes in isoflavone aglycones, during proofing, in soy bread dough added with 0, 2.5, 5.0, 7.5, and 10% almond.

FIG. 12 shows changes in β-glucosidase activity in soy bread containing almonds.

FIG. 13 illustrates the changes in the ratio of isoflavone β-glucosides to aglycone during bread preparation.

### DESCRIPTION OF THE EMBODIMENTS

Reference will now be made in detail to exemplary embodiments of the invention, examples of which are illustrated in the accompanying drawings.

The present invention is generally directed to methods involved in producing food products, and the food products made according to those methods. The food products can contain soy-based ingredients, including but not limited to, soy flour, soy milk, soy milk powder, soy isolates, soy concentrates, soybean slurry, soybean curd, soy germ (which is high in isoflavones), and isoflavones that are derived from soy products.

Food products made according to methods of the invention include, but are not limited to baked soy products, including but not limited to, soy bread, almond soy bread, almond plum soy bread, almond soy cake, soy bars, soy tortillas, soy bagels, soy crackers, soy muffins, and soy buns, as well as non-baked soy products, including but not limited to, soy drinks, including soy drinks with almond (yogurts, shakes, etc.), soy milk, soy cream cheese, soy pasta, tofus, tempehs, almond tofu, almond soy curd, almond soy texturized products (including imitation meat and snacks), almond soy pie, and almond soy pasta.

It is well established that soy-based products have a high concentration of isoflavones, which have been linked to a number of desirable physiological effects. As noted above, isoflavones in soy are found as aglycones or their conjugates (malonyl-β-glucosides, acetyl-β-glucosides, and β-glucosides), with glycosidic conjugates being the predominant forms in unprocessed soybeans. The bioavailability and biological activity of soy isoflavones is highly dependent on the chemical structures of these compounds. Recent clinical studies observed that isoflavone aglycones were absorbed faster and in greater amounts than their glycosylated forms.

It has surprisingly been found by the present inventors that by varying the times and temperatures during preparation of soy-containing products, isoflavone distribution of the food product can be modified. Temperatures that achieve the desired effect can range from about 22° C., 25° C., 27° C., 30° C., 32° C., 34° C., 36° C., 38° C., 40° C., 42° C., 44° C., 46° C., or 48° C. to about 70° C., 68° C., 66° C., 64° C., 62° C., 60° C., 58° C., 56° C., 54° C., 52° C., 50° C., 48° C., 46° C., 44° C., or 42° C. Of course, temperatures in between the recited values are also acceptable, as are ranges from any value to any value. The desired effect is an increase in β-glucosidase activity, which may be observable directly as an increased enzyme activity, and/or by an increased conversion of isoflavone glucosides to aglycones. It should be noted, of course, that the present invention is practiced by the methods disclosed herein—the result need not be identical.

Beta-glucosidase activity can increase by 10%, 50%, 100%, 200%, 250%, 500%, 1000%, etc., or any percentage in between, or even higher percentages. When measured by assaying its rate of hydrolysis of p-nitrophenyl-β-D-glucopyranoside at a temperature of 37° C. for 30 minutes at pH 4.6, enzyme activity can be greater than or equal to 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, or higher units (U).

The period to achieve the desired effect can vary, and this variation may relate to the temperature. The period can range from 30, 45, or 60 minutes, 1, 2, 3, or 4 hours, to about 6, 5, 4, 3, 2 or 1 hours. Of course, times in between the recited values are also acceptable, as are ranges from any value to any value. In some embodiments, the time and temperature will be from about 22° C. to about 56° C. for about 30 minutes to about 4 hours; in some embodiments, from about 32° C. to about 48° C. for about 1 to about 3 hours; in some embodiments, about 48° C. for about 2 hours. In the context of bread and of bread dough, this temperature/time step can be referred to as “proofing.”

Depending on the food product, the warming and holding step can be performed in any desired relative humidity. In the case of a bread product, for example, the relative humidity can be maintained at greater than about 50 percent and not greater than about 95 percent. The relative humidity can range from about 65 to about 90%, and from about 75 to about 85%, and can be about 80%.

The desired effect of increasing β-glucosidase activity can be augmented by adding 3-glucosidase, or an ingredient containing β-glucosidase. Examples of such ingredients include, but are not limited to, foods, such as grapes, raisins, wheat, rice, maize, white clover, cassaya, carrots, white lupin, and almond, and microbial sources, including but not limited to, yeast, fungal, and bacterial. Examples include, but are not limited to, fungus such as Sacharomyces strains including cerevisiae, rouxii, Sclerotinia Sclerotiorum; wine yeast, such as Hansenula spp., Candida molischiana, and C. wickerhamii; and bacteria, such as lactobacillus casei, Bacillus natto, Sacchropolyspora erythraea, Streptomyces sp., Rhizopus oligosporus, and Aspergillus sp. Other examples of microorganisms that produce glucosidase are described in U.S. Patent Application Publication No. 2003/0068329, the entire content of which is incorporated by reference.

In some embodiments, isolated β-glucosidase is added during processing. In some embodiments, the β-glucosidase has been engineered to increase its resistance to elevated temperatures, and thus, the engineered enzyme performs at higher heats.

The present inventors have also surprisingly found that by adding almonds, or almond-containing ingredients, β-glucosidase activity can be significantly increased. A secondary advantage of the addition of almonds, or almond-containing ingredients, is an improvement in the flavor of the product. Almonds can be added in raw or cooked form, and can be processed, such as by chopping, grinding, or pulverizing, to form chopped, ground, or powdered almonds. The almonds can be processed to an average particle size of less than or equal to about 1 mm, or less than or equal to about 0.1 mm.

Of course, the addition of β-glucosidase, such as in the form of almonds, can be combined with desired warming and holding conditions, to achieve an even greater increase in β-glucosidase activity. Thus, almonds can be added to the dough ingredients during mixing and the formed dough can be proofed for a desired time and temperature to achieve a desired effect. Additionally, the addition of an enzyme-rich ingredient, such as almond, can be practiced and be effective without the additional warming and holding step.

In some embodiments, the instant invention provides a mix and process for a superior soy protein-containing product, such as a bakery product, and more particularly a leavened bread, that has a soy protein content of at least 2 grams per serving. In some embodiments, the soy protein content is from about 2 to about 7 grams, or about 5, 6.25, or 6.5 grams per 50 gram serving. In some embodiments, the almond content of the product is from about 2% to about 20%, or more, by total weight. The almond content can be from 2, 3, 3, 4, 5, 6, 7, 8, 9, 10, 11, 12, 13, 14, 15, 16, 17, 18, or 19% by total weight. The almond content can be as high as 50%. A bread made according to this invention has a pleasant texture, comparable to more traditional wheat-based breads such as those containing eggs, for example, Challah bread.

In one embodiment, the present invention provides a mix for the production of soy-based bakery products. In some embodiments, the mixes of the present invention comprise a first premixture which comprises wheat flour, dough conditioner, gluten, and optionally, leavening agent, and a second premixture which comprises soy flour and dry soy milk, and optionally, sweetening agent. A third premixture can include shelled raw almonds, which can be processed by grinding or powdering before addition to the other ingredients. Other embodiments will contain more or fewer elements; for example, a premix may exclude dry soy milk.

In some embodiments, the invention utilizes a mix for the production of soy-based products, which mix comprises two dry ingredient premixtures, a yeast premixture, and an almond premix. The first dry ingredient premixture comprises wheat flour, dough conditioner, and gluten. The second dry ingredient premixture comprises soy flour, dry soy milk and sweetening agent. The third premixture is active yeast or a yeast proofing premixture comprising dry yeast, and sucrose. Again, shelled raw almonds are processed prior to mixing with the other premixes.

The wheat flour useful in the mixes of this invention is a high-gluten bread flour, which can be a strong, or high-protein-containing, high-gluten bread flour. Other wheat flours that can be used include, but are not limited to, high-gluten (high-protein) all purpose flour or cake flour. Soy flour may be used in its full fat, reduced fat, or defatted forms.

Some of the mixes of the present invention comprise soy milk and some of the products of the invention are made with soy milk. The use of soy milk in combination with wheat and soy flour has a highly desirable and unexpected effect on the overall quality of the resulting product, particularly bread. Mixes lacking soy milk provide a high quality bakery product with improved loaf volume, crumb texture and taste as compared to other soy-based bakery products when used according to the processes disclosed herein. However, inclusion of soy milk, such as dry soy milk, in the mixes of the present invention, provides products that are significantly improved. Dry powdered soy milk can be included in a premixture, or soy milk may be provided in its liquid form, which can be concentrated, and is not included in either of the dry ingredient premixtures.

In some embodiments, the leavening agent in the mixes of this invention is active yeast, which can be present in an amount of about 0.5 percent to about 10 percent by total weight, based on the weight of the mixture. As an alternative to active yeast, dry yeast can be used in an amount of about 0.5 percent to about 10 percent by total weight, based on the weight of the mix and is preferably provided in the form of a yeast proofing mixture. Other leavening agents include, but are not limited to, baking powder and baking soda and other microorganisms that produce carbon dioxide gas.

The mixes of the present invention can comprise a dough conditioner. The dough conditioner is generally selected from agents that provide lubrication to the dough, such as mono-and diglycerides, agents that serve as food source for yeast, such as ascorbic acid, and agents that serve to create chemical linkages between the gluten and soy components, such as L-cysteine or trans-glutaminase. Generally, any suitable commercial dough conditioner can be used; in some embodiments, a dough conditioner which comprises mono- and diglycerides, ascorbic acid and L-cysteine will be used. The dough conditioner can be present at a level of from about 0.9 percent to about 3 percent based on the weight of the mix.

The mixes of the present invention can include a sweetening agent. In addition to providing flavor enhancement, a sweetening agent is useful where yeast is used as the leavening agent—so that the yeast can more easily utilize the carbohydrates, which results in faster gas production as compared to other yeast food sources. One sweetening agent for the mixes of the present invention is sucrose. Other sweeteners include, but are not limited to, fructose, high-fructose corn syrup, honey, and fruit juice. Sweetening agent can be included in the mix at about 1 percent to about 15 percent by total weight, based on the weight of the mix.

In some embodiments, preservative agents such as calcium propionate or parabens can be added to the mixes of the present invention. The amounts of such preservatives are determined based on the agent selected and are in the range of about 0.1 percent to about 1 percent by total weight, based on the weight of the mix. Other ingredients that may be included in the mixes of the present invention include, but are not limited to, salt, flavorants, seasonings, and inclusions.

The mixes and/or final products according to the invention can also include isoflavones, in either glucoside or aglycone form. Thus, isoflavone glucosides or aglycones can be added during the processing steps.

Process for Making Bakery Products

It should be noted that the inventive methods of increasing β-glucosidase activity by maintaining a desired temperature for a desired time, and/or adding a β-glucosidase-containing ingredient, can be practiced with any other steps for making bakery products, or for making any other comestible. Such other steps are well known in the art. Examples of other steps for making soy-based bakery products are set forth in co-pending U.S. patent application Ser. No. 10/267,845, incorporated by reference herein.

Generally, dry ingredients, or premixes, will be kept separate from wet ingredients until the desired mixing time. When a β-glucosidase-containing ingredient, such as almond, is being used, it is desirable to process that ingredient shortly before mixing with the other ingredients, thereby maximizing the enzyme activity. If the enzyme-containing ingredient is processed earlier, steps can be taken to prolong or enhance enzyme activity. Indeed, regardless of when the enzyme-containing ingredient is processed, steps can be taken to prolong or enhance enzyme activity. Examples of such steps include, for example, processing at reduced temperatures, etc.

The inventive steps of maintaining the comestible at a desired temperature for a desired time, e.g., proofing in the bread-making process, can be practiced after moisture is added to at least some of the dry ingredients. For example, soy flour and soy milk (wet or dry), can be combined with water, optionally an enzyme-containing ingredient, and optionally other ingredients, and be held at 48° C. for two hours. Additional ingredients can be added after the inventive steps. Alternatively, all of the ingredients can be combined prior to the warming and holding steps. The order of the steps that can be practiced in accordance with the present invention will be readily apparent to those of skill in the art, and can be modified as desired without departing from the scope of the invention.

In some embodiments, additional food processing will follow the inventive steps of warming and holding the comestible, or of adding an enzyme-containing ingredient to the comestible. Such processing includes but is not limited to, extrusion and/or baking. Extrusion can be used for a variety of reasons, and can be performed at the same time as additional heating, such as at a temperature of from about 100° C. to about 300° C., or at about 200° C.

In the case of bread, for example, baking will generally follow the other inventive steps. In the case of soy-containing breads, it may be desirable to bake the dough at a temperature of about 325° F. to 375° F. The temperature can be kept under 349.9° F. to avoid the effect of Maillard browning, which causes a chemical reaction between protein and carbohydrate components of the bread to produce a darkened (“browned”) appearance. The oven temperature can be about 345° F. Of course, the oven temperature can be increased for an amount of time necessary to achieve a desired level of browning.

All of the comestibles and methods disclosed and claimed herein can be made and executed without undue experimentation in light of the present disclosure. While the comestibles and methods of this invention have been described in terms of specific embodiments, it will be apparent to those of skill in the art that variations may be applied to the composition, methods and in the steps or in the sequence of steps of the method described herein without departing from the concept, spirit and scope of the invention. More specifically, it will be apparent that certain ingredients, which are both biochemically and/or organolepitically related, may be substituted for the ingredients described herein, with an expectation of the same or similar results. All such similar substitutes and modifications apparent to those skilled in the art are deemed to be within the spirit, scope, and concept of the invention as defined by the appended claims.

The following examples are included to demonstrate preferred embodiments of the invention. It should be appreciated by those of skill in the art that the techniques disclosed in the examples that follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

### Effect of Proofing on the Distribution of Isoflavones in Soy Bread

Materials. Pure p-nitrophenol-β-D-glucopyranoside (pNPG), p-nitrophenol (PNP), sodium acetate, and sodium carbonate used for the β-glucosidase activity assay, and pure isoflavone standard compounds were purchased from Sigma (St. Louis, Mo.). All organic solvents and chemical reagents were HPLC grade and purchased from Fisher Scientific (Fair Lawn, N.J.). Soy flour was obtained from Archer Daniel Midland Co. (Decatur, Ill.). Soy milk powder was obtained from DevanSoy Farms (Carroll, Iowa).

Dough preparation. Soy bread doughs were prepared according to the following process, which is also described in U.S. application Ser. No. 10/267,845, the entire content of which is hereby incorporated by reference, that involves replacing 60% of wheat flour (General Mills, Minneapolis, Mich.) in wheat bread formula with soy flour and soy milk powder (Zhang et al 2003). The bread ingredients were combined and mixed in a 5-quart Kitchen Aid Mixer (Kitchen Aid Portable Appliance, St. Joseph, Mich.) to form doughs. The doughs were proofed at 32° C., 48° C., and room temperature for 1, 2, 3, and 4 hours using a proofer (CM2000 combination module, InterMetro Industries Corp, Wilkes-Barre, Pa.).

Isoflavones analysis. Isoflavones in soy bread doughs before and after proofing were extracted and analyzed for their isoflavone content and composition using methods described in details in Zhang et al. 2003. Dough sample (0.5 g) was ground to fine paste and extracted with 0.1N HCl (2 mL), acetonitrile (10 mL), and water (3 mL), at room temperature, for 2 hr. A Waters 2695 separation module (Milford, Mass.) fitted with a Waters 2996 photodiode Array Detector (“PDA”) was used to quantify the isoflavone content. The isoflavones in soy bread doughs were identified by comparison of retention time and UV absorbance patterns with pure isoflavone compounds.

β-glucosidase activity assay. The β-glucosidase activity in soy bread dough was determined using a modified method based on that of McCue and Shetty (2003). β-glucosidase activity in soy bread dough was extracted by mixing two gram of dough sample with distilled water (15 mL) and homogenizing for 1 min at 7,000 rpm (Polytron, Kinemetica AG, Littau-Switzerland), and then centrifuging at 10,000 rpm at 4° C. for 20 min using a Sorvall RC5Cplus refrigerated centrifuge (Ivan Sorvall, Inc., Norwalk, Colo.). The supernatant was collected and filtered through 0.48 μm filter before analysis.

Sample mixtures contained 0.1 mL of p-nitrophenol-β-D-glucopyranoside (9 mM, pH 4.6) in sodium acetate buffer, 0.8 mL of sodium acetate buffer (pH 4.6), and 0.1 mL of β-glucosidase extract from soy bread dough. Blank mixture contained 0.1 mL of distilled water instead of the enzyme extract. The reaction tubes were incubated at 37° C. for 30 min. The reaction was then stopped by addition of 1 mL of cold (4° C.) 100 mM sodium carbonate (pH=8). The released p-nitrophenol in each sample was determined by measuring the absorbance of each sample at 400 nm vs. blank using a UV spectrometer. One unit of enzyme activity is defined as the amount of enzyme that released 1 μmol of p-nitrophenol from the substrate pNPG, per mL per min under assay conditions.

Statistical analysis. Each sample was analyzed in triplicate. All data are expressed as means unless otherwise indicated. Statistical analysis was performed using the SAS software (SAS Inc, Cary, N.C.). Analyses of variance (ANOVA) using the general linear models (GLM) were conducted. Difference between the sample means were analyzed by Fisher's least significance (LSD) test at α=0.05.

Results

Soy bread dough before proofing contained about 190.3 nmol/gram of isoflavone aglycones, 924.4 nmol/gram of isoflavone β-glucosides, 1215 nmol/gram of malonylglucosides, and 164.0 nmol/gram of acetylglucosides. The isoflavones in unproofed soy bread dough had a β-glucosides to aglycone ratio of 4.9 and a β-glucosidase activity of about 27.7 U (control) (Table 1).

TABLE 1
Isoflavone content (dry basis)^{a} and β-glucosidase activity^{b}
of soy bread dough after proofing at 22, 32, and 48° C. for
1, 2, 3, and 4 hours

| | | β-glucosidase | Total | |
|---|---|---|---|---|
| Proofing | Proofing | activity | aglycone | |
| Temperature | time | (μmol/ | content | β-glucosides to |
| (° C.) | (hour) | ml · min) | (nmol/g) | aglycone ratio |
| N/A | 0 | 27.7 ± 0.6 | 190.3 ± 9.5 | 4.9 |
| 22.0 | 1.0 | 45.8 ± 2.3 | 196.9 ± 11.0 | 4.7 |
| | 2.0 | 43.8 ± 0.4 | 251.2 ± 8.5 | 3.5 |
| | 3.0 | 44.8 ± 1.3 | 313.0 ± 22.2 | 2.8 |
| | 4.0 | 43.1 ± 0.4 | 381.0 ± 12.1 | 2.3 |
| 32.0 | 1.0 | 26.6 ± 0.7 | 302.9 ± 13.4 | 2.8 |
| | 2.0 | 39.7 ± 0.3 | 579.9 ± 32.1 | 1.1 |
| | 3.0 | 38.8 ± 0.4 | 734.5 ± 13.1 | 0.7 |
| | 4.0 | 15.1 ± 0.5 | 962.9 ± 25.7 | 0.3 |
| 48.0 | 1.0 | 51.0 ± 1.0 | 489.5 ± 24.5 | 1.3 |
| | 2.0 | 34.4 ± 0.5 | 831.9 ± 41.6 | 0.4 |
| | 3.0 | 18.9 ± 0.6 | 879.9 ± 44.0 | 0.3 |
| | 4.0 | 0.0 ± 0 | 959.1 ± 47.9 | 0.2 |

^{a,b}Values are means ± SD of 4-6 independent determinations.

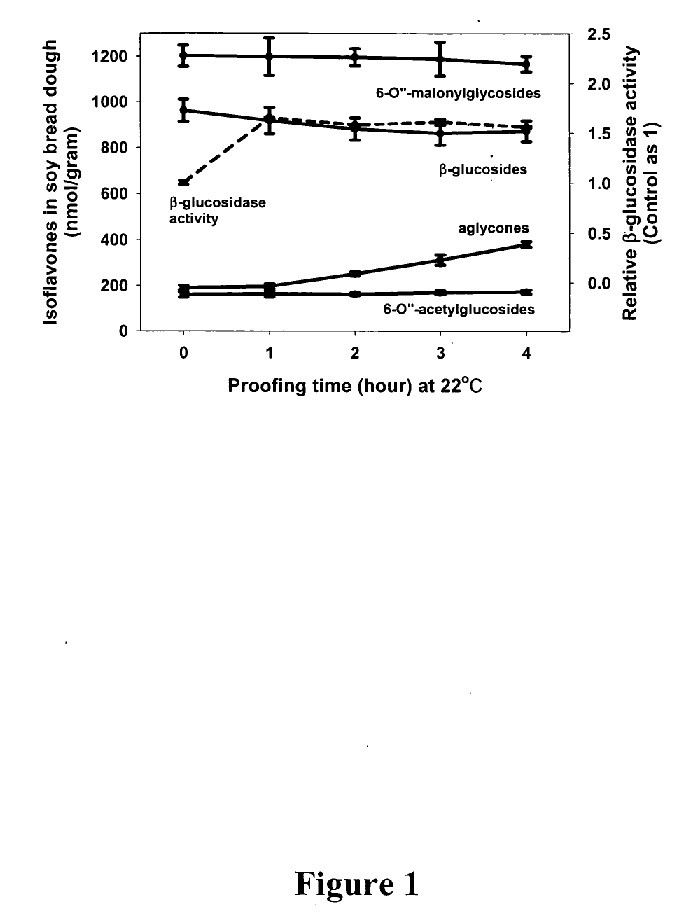

FIG. 1 shows the changes in isoflavones and β-glucosidase activity in soy bread at a proofing temperature of 22° C. β-glucosidase activity increased about 65.3% during the 1^{st} hour of proofing but remained practically unchanged through the 2^{nd} to the 4^{th} proofing hours (Table 1). The isoflavone aglycones increased by two-fold almost linearly, while isoflavone β-glucosides decreased about 5.5% during the four hours of proofing. These changes were reflected in the isoflavone β-glucosides to aglycone ratio that decreased from 4.9 to 2.3 (Table 1). Isoflavone malonylglucosides decreased about 9.7%. Isoflavone acetylglucosides did not change significantly (P>0.05).

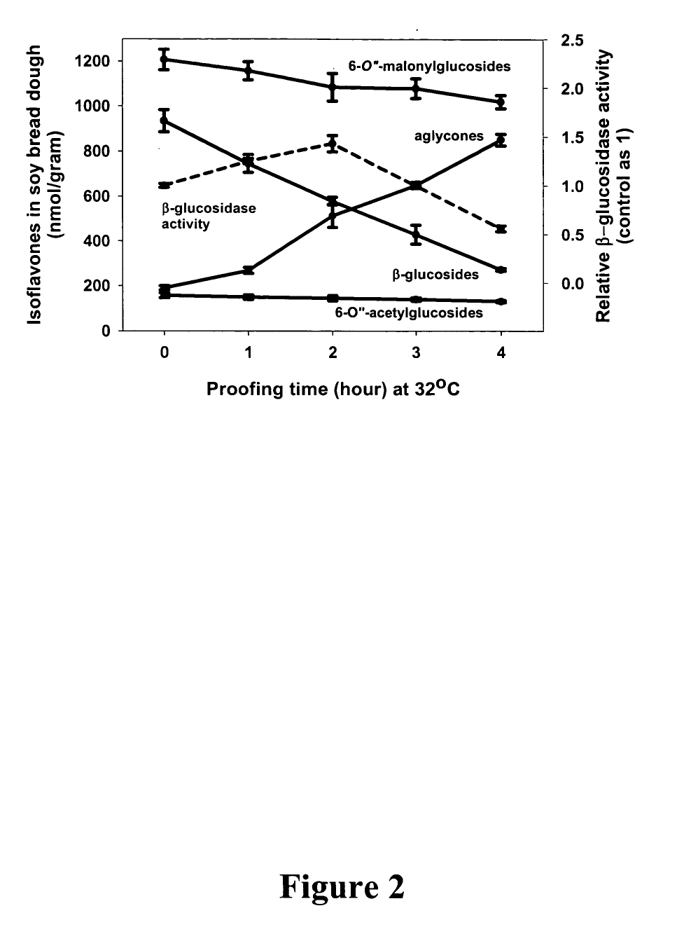

FIG. 2 shows the changes in isoflavones and β-glucosidase activity in soy bread at a proofing temperature of 32° C. β-glucosidase activity increased about 43.3% during the first two hours of proofing and then decreased about 61.9% during the last two hours of proofing. Isoflavone aglycones increased about two-fold in the first two proofing hours and an additional two-fold in the next two proofing hours. During the four-hour proofing at 32° C., isoflavone β-glucosides decreased about 66.7% linearly, and the isoflavone β-glucosides to aglycone ratio decreased from 4.9 to 0.3 (Table 1). However, 82.6% of the decrease in this ratio occurred during the first two hours of proofing. The isoflavone malonylglucosides decreased about 14.4% and acetylglucosides did not change significantly (P>0.05).

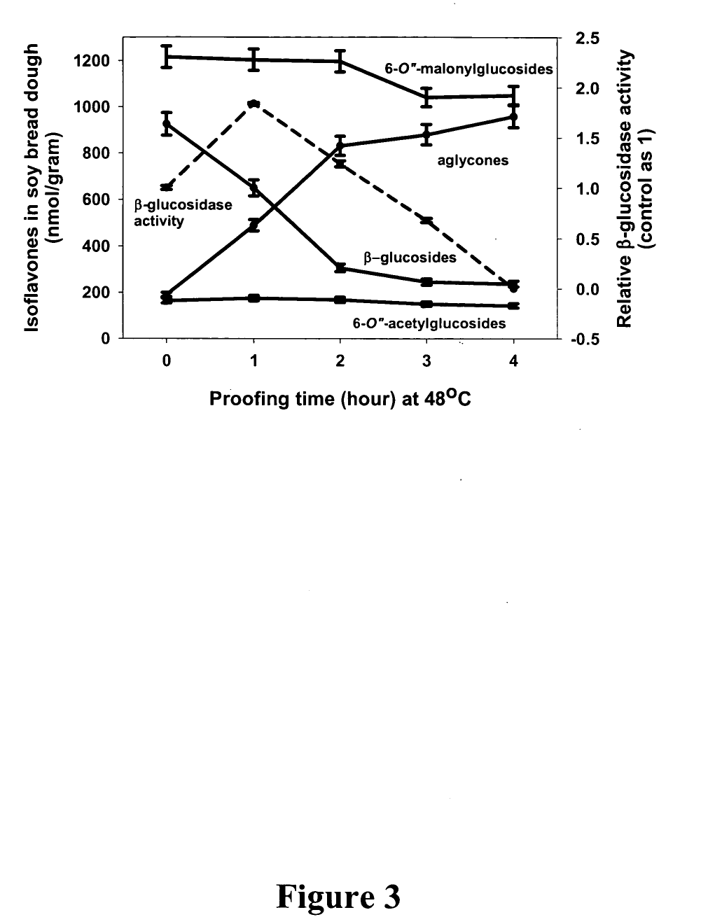

FIG. 3 shows the changes in isoflavones and β-glucosidase activity in soy bread at a proofing temperature of 48° C. β-glucosidase activity increased about 83.0% during the first proofing hour and then decreased during the last three hours of proofing until it reached zero. Isoflavone aglycones increased by 3.4 times in the first two proofing hours and an additional 66.7% in the next two proofing hours. During the four-hour proofing at 48° C., isoflavone β-glucosides decreased about 74.3% of which 90.0% occurred during the first two proofing hours. The isoflavone β-glucosides to aglycone ratio decreased from 4.9 to 0.2 and 78.3% of the decrease occurred during the first proofing hour. The isoflavone malonylglucosides decreased about 13.6% and acetylglucosides did not change significantly (P>0.05).

Discussion

For the three proofing temperatures, the increased β-glucosidase activity in soy bread dough was paralleled by a decrease in β-glucosides and simultaneous increase in aglycones. However, complete conversion of isoflavone β-glucosides to the aglycones was not observed in any of the proofing conditions studied as was observed by Pandjaitan et al. (2000) after adding an exogenous β-glucosidase to soy protein concentrate. This suggests a different hydrolysis mechanism between the enzymes of soybean origin and other sources (Pandjaitan et al. 2000; Tsangalis et al. 2003; Sue et al. 2000; Matsuura and Obata, 1993).

The increase in isoflavone aglycones may have resulted, at least partially, from enzymatic hydrolysis of isoflavone malonylglucosides during prolonged proofing. For example, after two hours of proofing at 48° C., isoflavone β-glucosides remained stable; isoflavone aglycones continued to increase during the next two hours of proofing along with a significant decrease in isoflavone malonylglucosides. Interestingly, the decrease in isoflavone malonylglucosides was steady throughout proofing for four hours at 22° C. (FIG. 1) but occurred in two stages at 48° C. (FIG. 3), indicating the selectivity of β-glucosidase may be somewhat temperature dependent.

The β-glucosidase activity in bread samples was assayed by determining the rate of hydrolysis of the substrate p-nitrophenyl-P-D-glucopyranoside (pNPG) at incubation temperature of 37° C. for 30 min (pH 4.6). β-glucosidase in soybeans have a range of reaction temperature of 10-50° C. over a range of pH 4.0-6.0 (Matsuura et al 1995), and its optimal temperature was found to be about 40° C. (Matsuura and et al 1995; Hsieh and Graham 2001). At proofing temperature of 22° C., soy bread dough maintained the potential to yield high β-glucosidase activity at optimal conditions (FIG. 1). However, the isoflavone aglycones were only doubled during the four-hour proofing in contrast to a four-fold increase when proofed at 48° C. at lower average enzymatic activity (FIG. 3). One possible explanation would be that the higher proofing temperature provides the activation energy of the enzyme-substrate reaction while lower temperature does not. A proofing temperature of 32° C. increased the enzymatic activity during the first two hours of proofing (FIG. 2) followed by a decrease in enzyme activity for the latter 2 hours. The decrease in enzyme activity may be due to the accumulation of fermentation products or enzymatic reaction products, i.e., acids and alcohols (Mateo and Stefano 1997), or the exhaustion of nutrients after prolonged proofing. β-glucosidase activity reached zero after four-hour proofing at 48° C. suggesting a complete loss of enzymatic activity after prolonged proofing at this temperature.

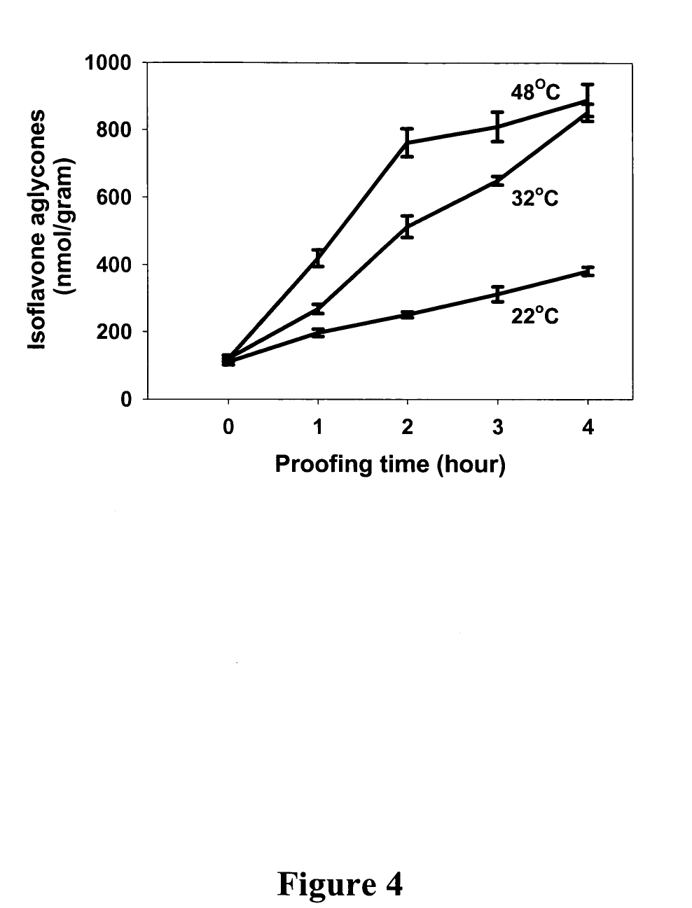

Among all combinations of proofing temperatures and times studied, β-glucosidase reached its maximal activity (51.0 U) in the shortest time (1 hr) during proofing at 48° C. At 22° C. and 32° C., the time required to reach the maximal activity of this enzyme was 1 and 2 hours, respectively. The production of isoflavone aglycones in soy bread reached a maximum after proofing at 48° C. for 2 hours (FIG. 4). Therefore, proofing at 48° C. for two hours was considered the optimal condition for high isoflavone aglycone production in soy bread preparation. These results also suggested that β-glucosidase activity in soy bread dough is time dependent, as was found for soy milk (Masaru and Obata 1993), and temperature dependent.

In conclusion, β-glucosidase activity in soy bread dough was time and temperature dependent. Both isoflavone β-glucosides and malonylglucosides were used as substrates for β-glucosidase to produce isoflavone aglycones. However, isoflavone β-glucosides were preferred to isoflavone malonylglucosides in this enzyme-substrate reaction. The production of isoflavone aglycones is manipulated by controlling the time and temperature of proofing. The proofing temperature at 48° C. for two hours was found to be optimal in soy bread.

### Example 2

### Changes in Distribution of Isoflavones and β-Glucosidase Activity During Soy Bread Proofing and Baking

Methods and Materials

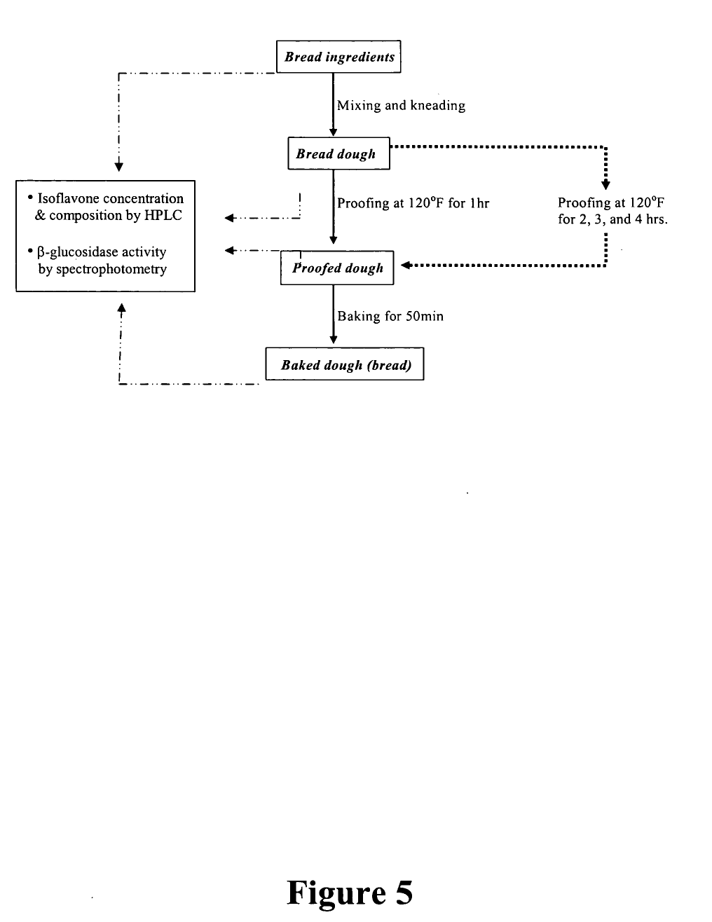

Materials. Pure p-nitrophenol-β-D-glucopyranoside (pNPG), p-nitrophenol (PNP), sodium acetate and sodium carbonate were used for β-glucosidase activity assay and pure isoflavone standard compounds were purchased from Sigma (St. Louis, Mo.). All organic solvents and chemical reagents were HPLC grade and purchased from Fisher Scientific (Fair Lawn, N.J.). Soy flour was obtained from Archer Daniel Midland Co. (Decatur, Ill.). Soy milk powder was obtained from DevanSoy Farms (Carroll, Iowa). The experimental plan of this study is shown in FIG. 5.

Samples were obtained from soy bread ingredients, dough before proofing, dough after proofing, and dough after baking (soy bread). Isoflavone content and β-glucosidase activity in these samples were measured as described below. The changes in isoflavone content and composition and their correlations with β-glucosidase activity were studied.

Bread preparation. The main ingredients in soy bread making are presented in Table 2. Soy bread was prepared using the following process, which is also described in copending U.S. patent application Ser. No. 10/267,845, that involves replacing 60% of wheat flour (General Mills, Minneapolis, Mich.) in wheat bread formula with soy flour and soy milk powder. The bread ingredients were combined and mixed in a 5-quart Kitchen Aid Mixer (KitchenAid Portable Appliance, St. Joseph, Mich.) to form dough. The dough was proofed at 48° C. for 1, 2, 3, and 4 hours (denoted Dough A, B, C, and D, respectively) in a proofer (CM2000 combination module, InterMetro Industries Corp, Wilkes-Barre, Pa.), and baked at 165° C. in a jet air oven (Model: JA14, Doyon, Liniere, Quebec, Canada) for 50 minutes. Bread samples (denoted Bread A, B, C, and D from Dough A, B, C, D, respectively) were collected and extracted immediately after baking.

TABLE 2
Soy bread formula^{a}

| | Soy bread |
|---|---|
| Ingredients | % (w/w) |
| H₂O | 45.3 |
| Soy milk powder | 6.6 |
| Soy flour | 20.0 |
| Wheat flour | 17.5 |
| Pure gluten | 2.3 |
| Dough conditioner | 0.2 |
| Sugar | 4.5 |
| Yeast | 1.0 |
| Salt | 0.9 |
| Shortening | 1.7 |

^{a}Ingredients were added as is (wet basis).

Extraction of isoflavones from bread samples. Isoflavones in soy ingredients, dough before and after proofing, and after baking (soy bread), were extracted and analyzed for their isoflavone content and composition. Bread samples (0.5 g) were ground to a fine paste and mixed with 0.1N HCl (2 mL), acetonitrile (10 mL), and water (3 mL). The mixture was shaken with a multi-wrist shaker (Lab-line Instrument Inc, Melrose Park, Ill.) at speed 9 at room temperature for 2 hr and centrifuged at 430 g for 30 minutes in a centrifuge (IEC HN-SII, Damon/IEC Division, Needhamhts, Mass.). One milliliter of the supernatant was collected and dried under nitrogen with an evaporating unit (Pierce Model 18780, Rockford, Ill.). Dried residue was redissolved in 1 ml of 100% methanol and stored at −20° C. for subsequent HPLC analysis.

HPLC analysis. A Waters 2695 separation module (Milford, Mass.) fitted with a Waters 2996 Photodiode Array Detector (“PDA”) was used to quantify the isoflavone content. Separation of isoflavones was achieved using a Waters Nova-Pak C18 reversed-phase column (3.9×150 mm; i.d. 4 μm, 60 Å pore size). The PDA detector monitored a wavelength range of 210-400 nm, and the eluting compounds were detected at 260 nm. The mobile phase consisted of 1.0% acetic acid in water (v/v) (solvent A) and 100% acetonitrile (solvent B). The elution condition was as follows: 0-5 min 15% B, 5-36 min 15-29% B, 36-44 min 29-35% B, 44-45 min 35-15% B, re-equilibrate at 15% B for 5 min for next run. Flow rate was set at 0.6 ml/min. Injection volume was 10 μL. The isoflavones in soy ingredients and bread samples were identified by HPLC retention time and UV absorbance spectra in comparison to pure authentic isoflavone standards.

Analysis of β-glucosidase activity from bread ingredients and bread samples. Two grams of food sample from each soy bread ingredient, dough proofed for 1-4 hours at 48° C., and baked bread (2.0 g) were mixed with distilled water (15 mL) and homogenized for 1 min at 7,000 rpm (Polytron, Kinemetica AG, Littau-Switzerland), and then centrifuged at 10,000 rpm at 4° C. for 20 min using a Sorvall RC5C plus refrigerated centrifuge (Ivan Sorvall, Inc., Norwalk, Conn.). The supernatant was collected and filtered through 0.2 μm filter. The resultant extract was stored at 2° C. for no longer than 4 hours before analysis.

β-Glucosidase activity assay. The β-glucosidase activity in bread ingredients and bread samples was determined using a modified method based on that of McCue and Shetty (2003). Nine mM of p-nitrophenol-β-D-glucopyranoside (pNPG) in 200 mM sodium acetate buffer (pH 4.6) was prepared as a substrate for β-glucosidase in the food samples. Sample mixtures contained 0.1 mL of p-nitrophenol-β-D-glucopyranoside in sodium acetate buffer, 0.8 mL of sodium acetate buffer, and 0.1 mL of β-glucosidase extract from food samples. Blank mixtures contained 0.1 mL of distilled water instead of the enzyme extract. The reaction tubes were incubated at 40° C. for 30 min. The reaction was then stopped by addition of 1 mL of cold (4° C.) 100 mM sodium carbonate (pH=8). The reaction mixtures were clarified by centrifugation at 10,000 rpm at room temperature for 1 min. The released p-nitrophenol in each sample was determined by measuring the absorbance of each sample at 400 nm vs. blank using a UV spectrometer. One unit of enzyme is defined as the amount of enzymes that released 1 μmol of p-nitrophenol from the substrate pNPG, per mL per min under assay conditions.

Statistical analysis. Each sample was analyzed in triplicate. All data were expressed as means unless otherwise indicated. Statistical analysis was performed by using SAS software (SAS Inc, Cary, N.C.). Analyses of variance (ANOVA) using the general linear models (GLM) were conducted. Difference between the sample means were analyzed by Fisher's least significance (LSD) test at α=0.05.

Results and Discussion

Changes in Isoflavone Content and Composition During Bread Making

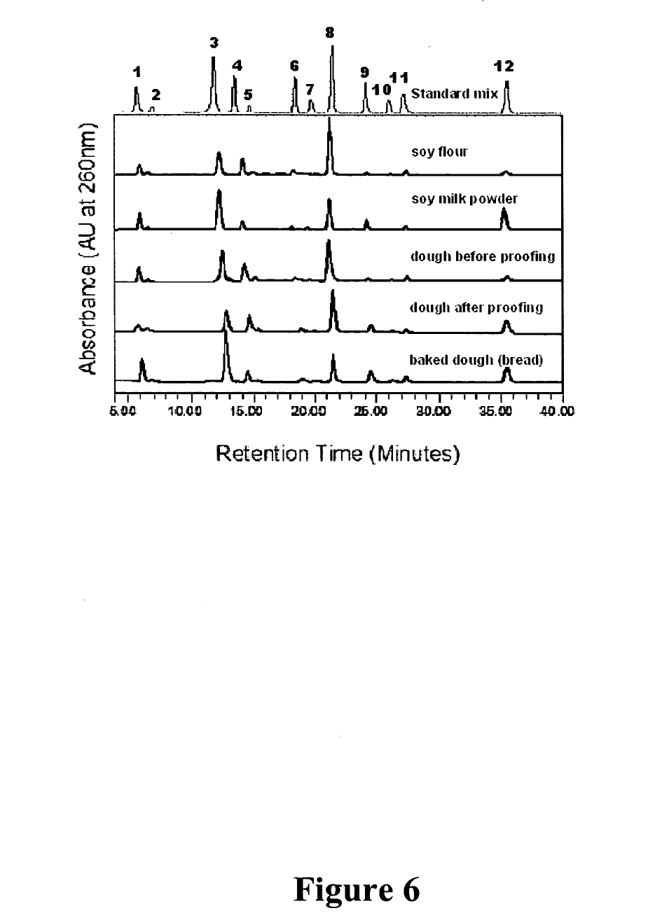

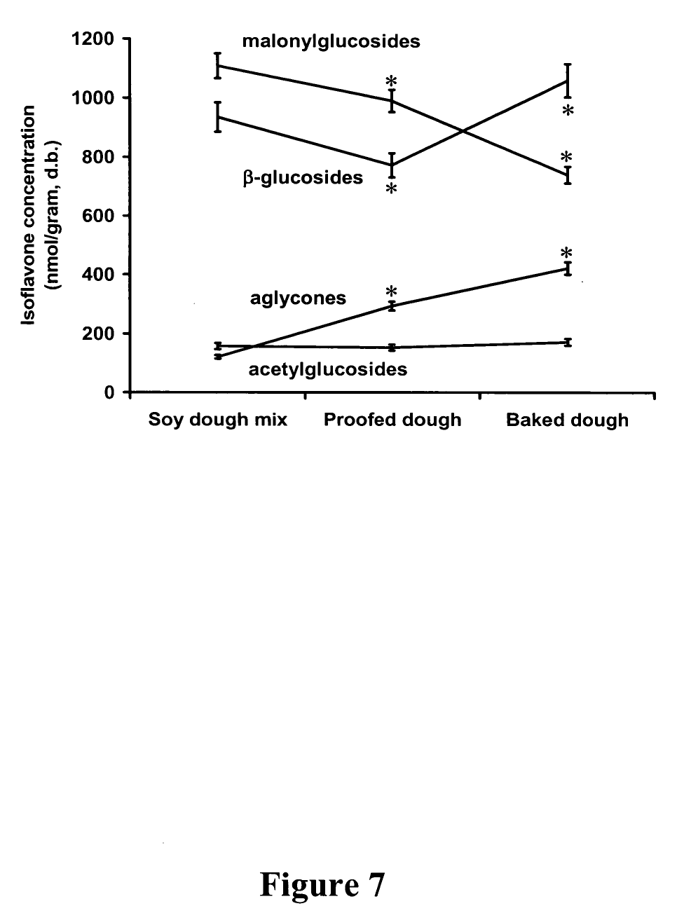

The isoflavone concentration in soy flour, soy milk powder, soy bread dough before and after proofing (Dough A), and soy bread (Bread A) are shown in FIG. 7. Twelve isoflavones (3 aglycones and their corresponding derivatives) were clearly separated, identified and quantified (FIG. 6) by HPLC. Isoflavones (715 mg) in the starting ingredients (soy flour and soy milk powder) were largely recovered in soy bread (614 mg/loaf, indicating only a minor degradation of isoflavones during bread making. However, isoflavone composition was largely altered (FIG. 7).

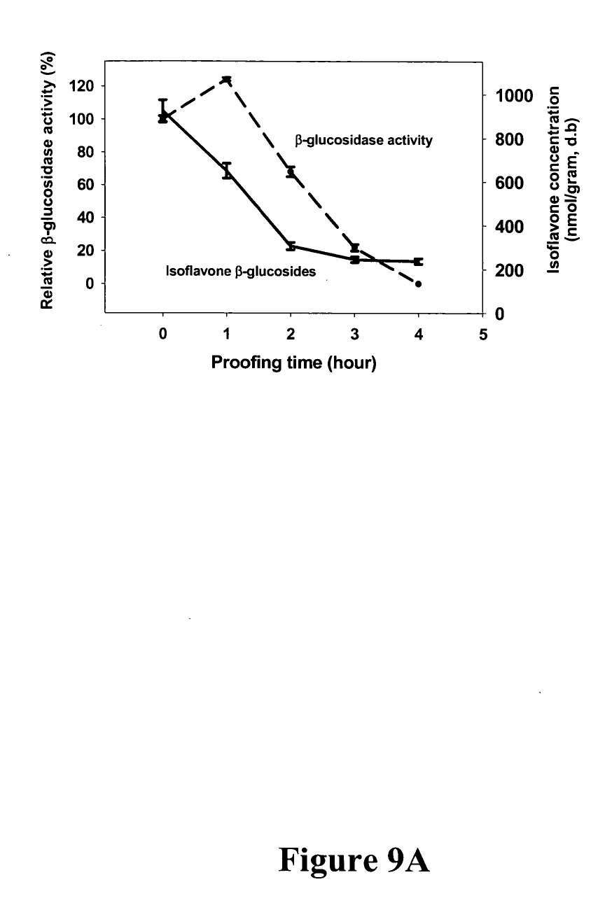

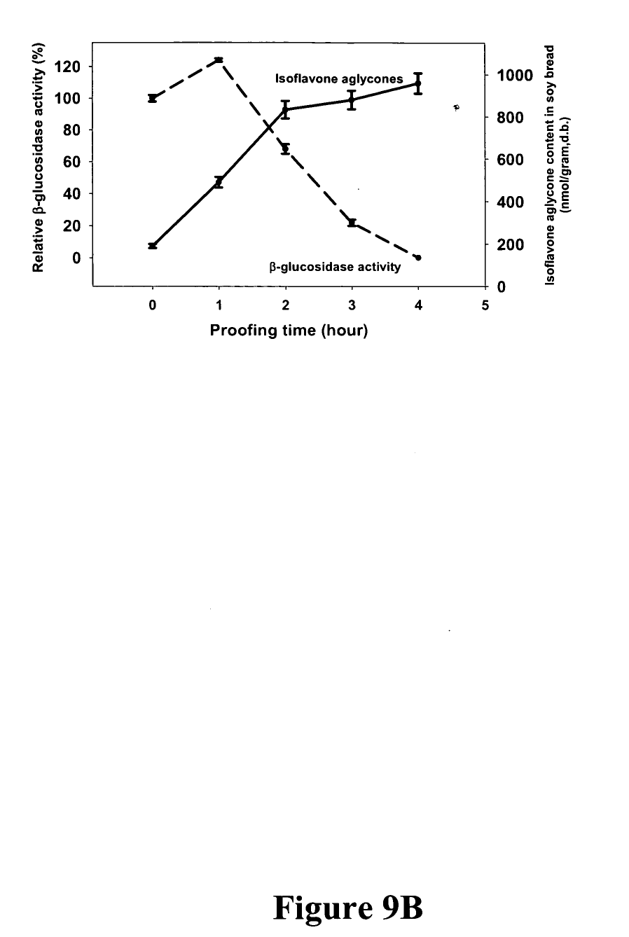

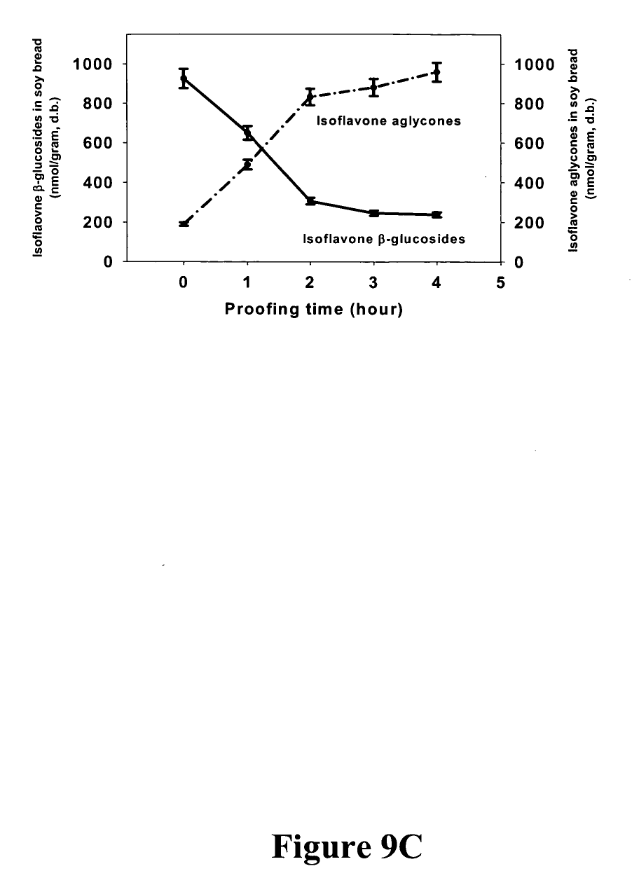

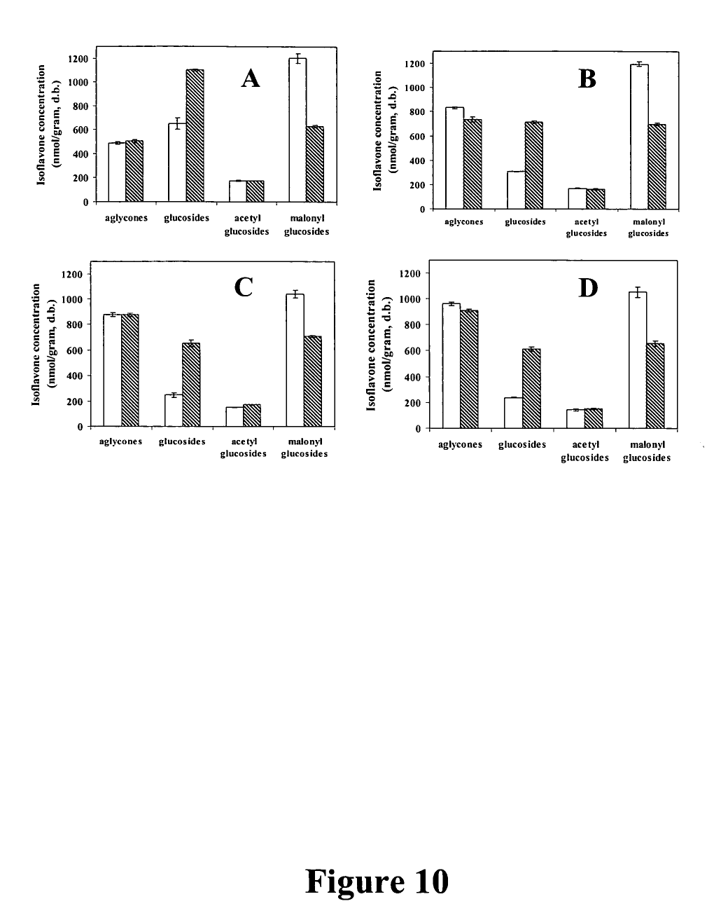

In the first step of bread making, soy ingredients were mixed with other bread ingredients, i.e., wheat flour, water, and yeast, to form a dough. No significant change in the isoflavone content and composition was observed during mixing and kneading (3,000 rpm on average, 15 min). No significant degradation of isoflavones was observed during proofing (48° C., 1 hr). However, proofing caused significant changes (p<0.05) in isoflavone composition, including an increase in aglycones (+157%) and a decrease in β-glucosides (−29.7%) as compared to soy ingredients (aglycones: 190 nmol/g, β-glucosides: 924 nmol/g, in dough before proofing) (FIG. 9). The amount of acetylglucosides decreased only slightly during proofing (−6.7%). The amount of malonylglucosides was unchanged. During baking (165° C., 50 min), significant changes (p<0.05) in isoflavone composition were observed including a decrease in malonylglucosides (47.7%) and an increase in β-glucosides (+69.3%) as compared to soy bread dough before baking. No significant change in either isoflavone acetylglucosides or aglycones was observed. The decrease in isoflavone concentration in bread during baking was −4.2%, attributed mainly to thermal decomposition or irreversible binding to other bread components.

The main increase in isoflavone aglycones in the proofing stage of the current bread-making process occurred with a decrease in isoflavone β-glucosides. To investigate the mechanism leading to isoflavone aglycones production in soy bread, variable proofing times of the soy bread dough before baking was studied.

Effect of β-Glucosidase Activity and Bread Making on Isoflavones

The β-glucosidase activity in bread ingredients (yeast, soy ingredients, and wheat flour) and bread samples was determined using a colorimetric method. The β-glucosidase activity in bread yeast was low (0.66 U) as compared to soy flour (10.7 U) soy milk powder (6.83 U) and wheat flour (4.14 U). Our results are consistent with results from Gunata et al (1986) which show that yeast (Saccharomyces) have a very low β-glucosidase activity. Sue et al (2000) observed that the β-glucosidase from wheat was capable of hydrolyzing p-nitrophenol β-glucosides, as well as flavone and isoflavone glucosides. Therefore, wheat flour, a major bread ingredient in this soy bread formula, may also contribute to the total β-glucosidase activity along with soy ingredients.

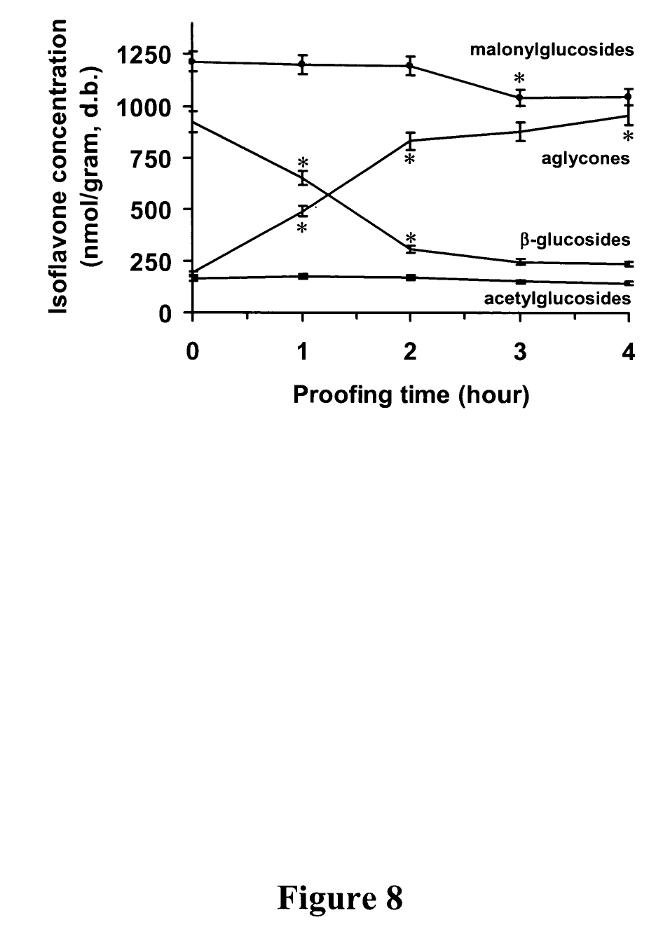

The changes in isoflavone content and composition (FIG. 8) in dough proofed for 14 hours at 48° C. and the changes in β-glucosidase activity (FIG. 9) were studied. The β-glucosidase activity in soy bread dough before proofing was used as a control. During the first hour of proofing, the β-glucosidase activity in the dough increased sharply (+22%) in conjunction with a decrease in isoflavone β-glucosides (−30%) and an increase in isoflavone aglycones (+15%). After the first hour of proofing, the β-glucosidase activity in dough began to decrease while the isoflavone β-glucosides continued to decrease quickly until the end of the second hour. During the 3^{rd} hour of proofing, the β-glucosidase activity in the dough continued to decrease (from 65% to 20%), with a slower decrease in isoflavone β-glucosides (−8%), and reached a plateau by the 4^{th} proofing hour. During the first three proofing hours, the decrease in isoflavone β-glucosides (−75%) and subsequent increase in aglycones (+78%) correlated very well (r=−0.99) suggesting that the increase in aglycones resulted largely from the deconjugation of β-glucosides. No direct conversion from either isoflavone acetylglucosides or malonylglucosides to form isoflavone aglycones was observed until the level of isoflavone β-glucosides reached 300 μmol/gram soy bread. This observation indicates a high specificity of β-glucosidase activity in the bread system for hydrolytic cleavage of β-D-glucose to form isoflavone aglycones. The decreased amount of aglycone formation after more than 2 hours of proofing could be due to lack of substrates or inhibition of β-glucosidase activity by increasing fermentation by-products, as suggested in a study on the β-glucosidase activity of different Saccharomyces strains (Mateo and Stefano, 1997). However, isoflavone aglycones continued to increase slightly through the 3^{rd} and 4^{th} proofing hours while isoflavone β-glucosides reached a plateau after the 3^{rd} hour.

Isoflavone malonylglucosides were stable through two hours of proofing but decreased slowly during the 3^{rd} hour of proofing. Meanwhile, isoflavone aglycones continue to increase in the 3^{rd} and 4^{th} hour of proofing even though the β-glucosides reached a plateau after the 3^{rd} hour. This phenomenon indicates the possibility of the conversion of isoflavone malonylglucosides to free aglycones when the level of isoflavone β-glucosides was limited for subsequent deconjugation. An alternative explanation may involve the slower rate of conversion for isoflavone malonylglucosides in comparison to isoflavone β-glucosides. No degradation or deconjugation was observed for isoflavone acetylglucosides during proofing.

To assess the impact of baking on isoflavones, the doughs after prolonged proofing (1-4 hr) were baked at 165° C. for 50 min. The isoflavone content and β-glucosidase activity in these breads (Bread A, B, C, and D) were determined (FIG. 6). No β-glucosidase activity was found in any of the bread samples indicating the inactivation of enzyme activity by baking.

Significant changes in isoflavone composition in all breads were observed in compared to dough after proofing including a large increase in β-glucosides (varied from +30% to +57%) and a large decrease in isoflavone malonylglucosides (varied from −25% to 45%).

The isoflavone aglycone levels in breads after baking (Bread A, B, C, and D) were similar to those after proofing and before baking (Dough A, B, C, and D), suggesting that the thermal condition (165° C. for 50 min) during baking does not change the aglycone content. The amount of isoflavone aglycones in bread samples were determined during the proofing stage and were found to be dependent on the extent of proofing time at 48° C. On the other hand, the final level of β-glucosides in soy bread were influenced by both proofing and baking steps of the bread making process. Regardless of prolonged proofing and baking, the level of isoflavone acetylglucosides remained unchanged suggesting that these derivatives are very stable through the bread making process. The change in isoflavone acetylglucosides in soybean products during processing has been shown to be an indication of severe thermal treatment. Coward et al (1998) suggested the production of isoflavone acetylglucosides by dry heat was favored as compared to moist heat at the same temperature. Our results are consistent with their findings regarding the production of isoflavone β-glucosides instead of acetylglucosides in batters under highly moist thermal conditions.

Conclusions

Proofing and baking have important but different roles in changing the distribution of isoflavones in soy bread. Proofing is key in the conversion of isoflavone β-glucosides to isoflavone aglycones in bread dough by highly specific β-glucosidase activity without degrading isoflavones. The P-glucosidase activity likely arises from soy ingredients and wheat flour rather than yeast. Heat applied during baking significantly decreases isoflavone malonylglucosides and increases isoflavone β-glucosides. Baking does not affect either aglycones or acetylglucosides of isoflavones. Enzyme activity during proofing and the balance between formation and deconjugation of isoflavones during baking determine the isoflavone content and composition in the final product. Since isoflavone aglycones are known to be readily absorbed after consumption, these chemical changes during the bread making process may enhance bioavailability of the biologically active forms of isoflavones.

### Example 3

### Addition of Almond to Increase Isoflavone Aglycones in Soy Bread

Examples 1 and 2 show how proofing contributes to most of the increase in aglycones (90%) during the bread-preparation process. This Example demonstrates how the isoflavone aglycones can be further increased by adding a source of β-glucosidase. More particularly, this Example shows the effect of β-glucosidase from almonds on the aglycone level in soy bread during proofing.

Material and Methods

Raw almond was purchased from local grocery store (WildOat, Columbus, Ohio). Almond was ground to a fine powder using a coffee mill. Almond powders (5.0% and 10.0%, w/w) were mixed with soy bread ingredients to form doughs. The ingredients and equipment used for the bread preparation are shown in Tables 3 and 4.

Table 3: Ingredient List for Almond-Containing Soy Bread

TABLE 3
Ingredient List for Almond-Containing Soy Bread

| Ingredient | Brand | Manufacturer |
|---|---|---|
| Yeast | Red Star Instant Active | Universal Foods Corporation, Milwaukee, |
| | Dry Yeast | Wisconsin, 53202 |
| Sugar | Kroger | The Kroger Co., Cincinnati, Ohio 45202 |
| Wheat Flour | Bakers High Gluten | General Mills Operations, Inc. Minneapolis, |
| | Enriched Bromated | Minnesota, 55440 |
| | Flour Bleached | |
| Gluten | Vital Wheat Gluten | Hodgson Mill, Inc. VWG P.O. Box 430. |
| | with Vitamin C | Teutopolis, IL 62457 |
| Dough Conditioner | Caravan Products | Totowa, NJ 07512 |
| | Company | |
| Soy Milk Powder | Devansoy Farms | Carroll, IA51401 |
| Soy Flour | ADM | ADM Protein Specialties Division, Decatur, |
| | | IL62525 |
| Salt | Kroger Iodized salt | The Kroger Co., |
| Shortening | Crisco All-vegetable | Procter & Gamble, POBox 5558, Cincinnati, |
| | Shortening, 50% less | OH45201 |
| | Saturated fat than | |
| | butter | |
| Raw Almond | White Oats | |

TABLE 4
List of Equipment for Making Almond Containing Soy Bread

| Equipment | Brand/Model | Manufacturer |
|---|---|---|
| 5-quarter Mixer with | KitchenAid, 350Watt | KitchenAid Portable Appliance, St. Joseph, |
| pedal and dough | | MI 49085 |
| hooker | | |
| Proofer | CM2000 combination | InterMetro Industries Corp, Wilkes-Barre, PA |
| | module | |
| Jet Air Oven | Model: JA14, | Doyon, Liniere, Quebec, Canada |
| Balance | Max. Cap. 3100 g | Mettler-Toledo Inc. |
| 5-digit Balance | Max. 220 g, Min. 10 mg | Mettler-Toledo Inc. |
| Coffee Bean Mill | Black&Decker/ | Applica Consumer Products, Inc. Shelton, CT |
| | SmartGrind Deluxe | 06484 |

The steps for making the bread are provided in detail as follows.

PREPARATION: Raw almond was ground to a fine powder using a coffee grinder (setting: fine; seconds: 100). The proofer was turned on, the temperature set to 120° F., humidity set at medium to high (i.e., setting 7 out of 10), and a container of water (500 mL) placed in the proofer. The jet air oven was turned on and the temperature set at 310° F.

STEP 1: Yeast (12.8 g) was combined with 4 g sugar and dissolved in 61 g water. The mixture was maintained at room temperature.

STEP 2: Wheat flour (232.5 g) was combined with 30 g gluten, 2.5 g dough conditioner, 253 g water in a mixing bowl. Calcium propionate was added as an inhibitor of bacterial growth. The ingredients were mixed (KitchenAid 350 Watt Mixer) using a pedal, at speed 3, until the mixture turned into dough and started to splash the bowl. Mixing was continued for one more minute.

STEP 3: The pedal was removed from the mixer and a dough hook added in its place. To the dough in the mixing bowl was added the yeast mixture from STEP 1, along with 88.4 g soy milk powder, 264.8 g soy flour, 56 g sugar, 12.2 g salt, 23.1 g shortening, 289 g water, and 55 g raw almond powder (from PREPARATION step). The combination was mixed for about 30 seconds at speed 2 (medium), then allowed to rest for about 5 minutes. Mixing was then continued at speed 3 for 5 minutes.

A tabletop was dusted with wheat flour. The formed dough was removed from the mixer, placed on the dusted tabletop, and kneaded (about 20 times) by hand. The kneaded dough was placed in a 2-lb loaf baking pan. The doughs were proofed at 48° C. for 1 hour. Isoflavones in these doughs were extracted and analyzed and β-glucosidase activity was monitored.

The entire process was repeated without almond powder, to make the control dough and bread.

Results and Discussion

Isoflavone Compositions in Soy Bread

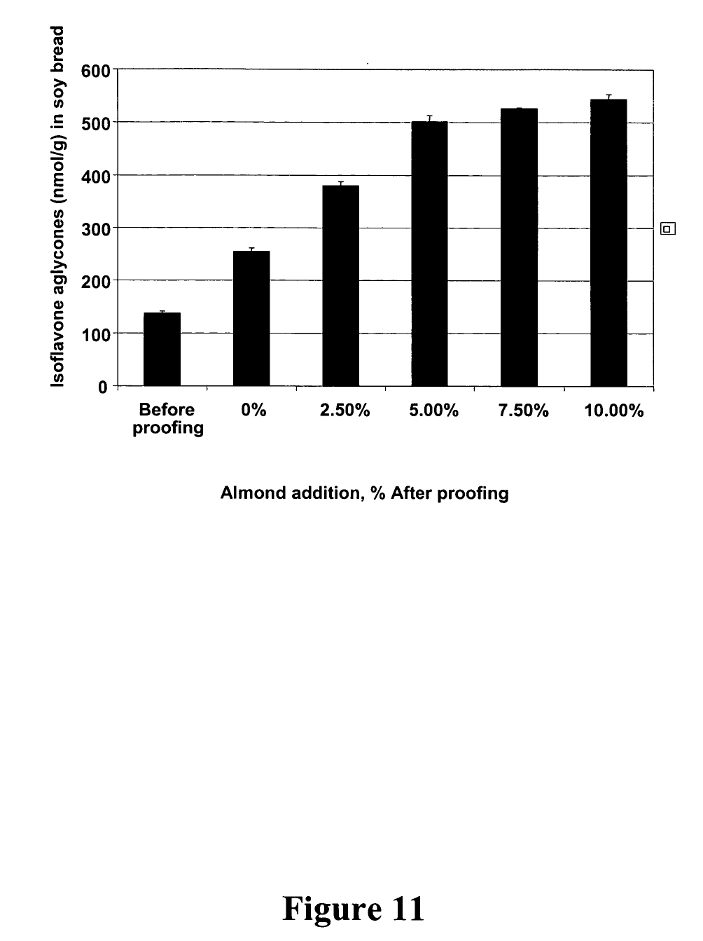

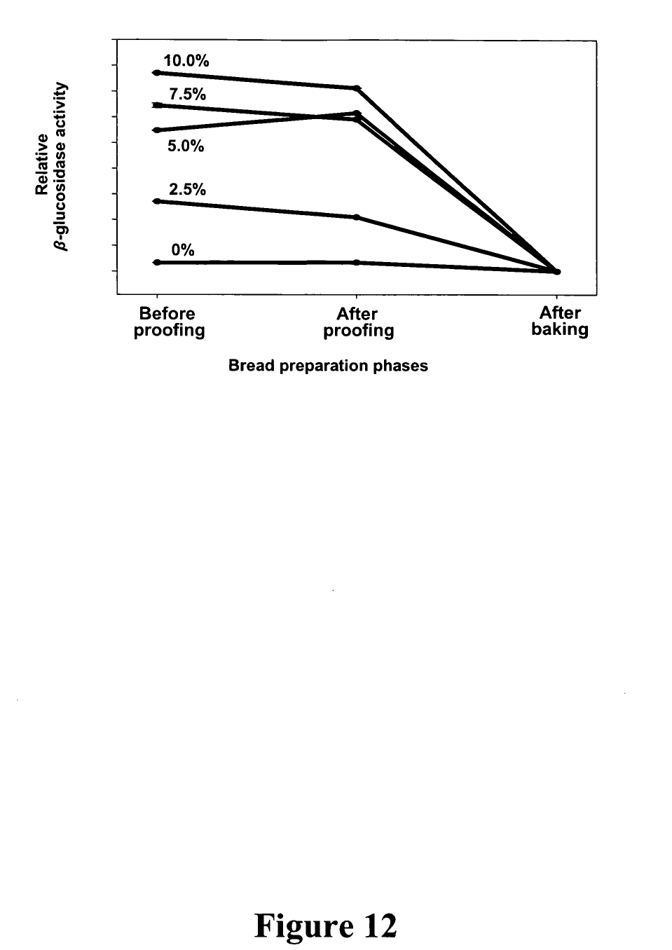

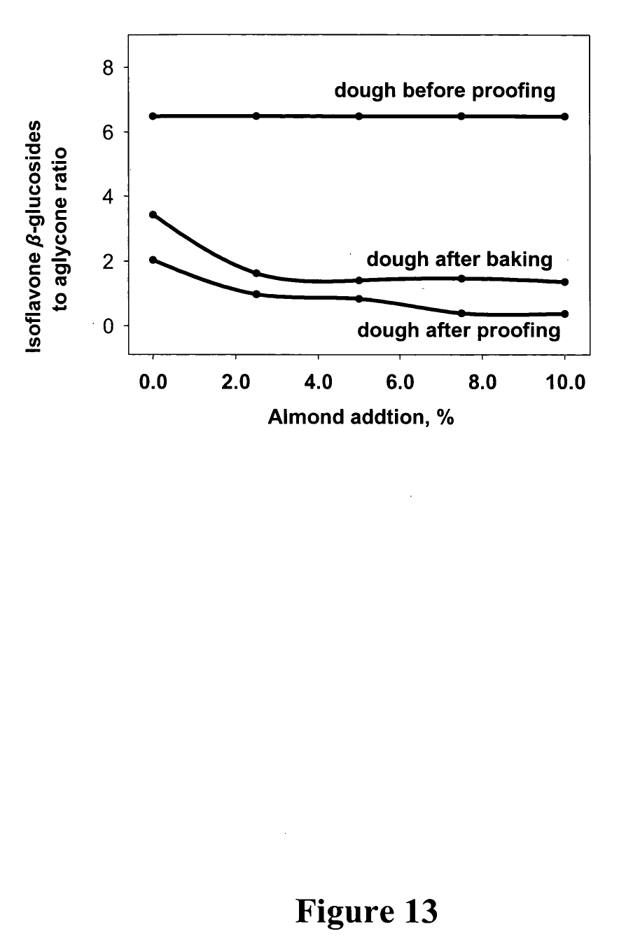

The aglycone concentrations of control soy bread and soy bread containing 5 and 10% almond powder were 302, 580, and 600 nmol/g, respectively (FIG. 11).

Isoflavone aglycones increased 84% in control bread during proofing, while aglycones in soy bread dough containing 5% almond increased approximately 264%. The increase in isoflavone aglycones for soy bread containing 5% and 10% during proofing was similar. The increase in isoflavone aglycones during baking was about 9% of overall increase during bread preparation.

The increases in isoflavone aglycones corresponded to a decrease in isoflavone β-glucosides (−13.7% for control bread; −35.4% for 5.0% almond addition; −63.1% for 10.0% almond addition). Among the four levels of almond added, 5.0% was optimal and resulted in soy bread with a large increase (364%) in isoflavone aglycones in contrast to increase in control soy bread and soy bread containing 10% almond (184 and 395%, respectively) (FIG. 11).

β-Glucosidase Activity in Soy Bread

Almond addition increased β-glucosidase activity in soy bread dramatically; 16× and 23× for 5% and 10%, respectively (FIG. 2).

The changes in isoflavone β-glucosides to aglycone ratio during bread preparation is shown in FIG. 3. The increased β-glucosidase activity in soy bread dough was paralleled by a decrease in the isoflavone β-glucosides to aglycone ratio suggesting the action of β-glucosidase on isoflavone β-glucosides to free isoflavone aglycones.

Conclusion

Enzyme-rich almond powder plays an important role in increasing aglycone content in soy bread. Among the levels of almond addition studied, 5% almond level seems to be optimal for β-glucosidase activity and increase in isoflavone aglycones in soy bread. These findings provide a food process to potentially improve the level of bioactive components and bioavailability of isoflavones in soy bread and other soy foods.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Unless otherwise defined, all technical and scientific terms used herein have the same meaning as commonly understood by one of the ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

The specification is most thoroughly understood in light of the teachings of the references cited within the specification, all of which are hereby incorporated by reference in their entirety. The embodiments within the specification provide an illustration of embodiments of the invention and should not be construed to limit the scope of the invention. The skilled artisan recognizes that many other embodiments are encompassed by the claimed invention and that it is intended that the specification and examples be considered as exemplary only, with a true scope and spirit of the invention being indicated by the following claims.

1. A method of increasing the isoflavone aglycone concentration in a soy-containing comestible comprising maintaining the comestible in a temperature of from about 20° C. to about 70° C., for a period of from about 1 minute to about four hours, wherein the method results in an increase in isoflavone aglycone concentration.

2. The method according to claim 1, wherein the temperature is from about 30° C. to about 60° C.

3. The method according to claim 2, wherein the temperature is from about 40° C. to about 50° C.

4. The method according to claim 3, wherein the temperature is from about 45° C. to about 48° C.

5. The method according to claim 1, wherein the period is from about 1 to about 3 hours.

6. The method according to claim 5, wherein the period is about 2 hours.

7. The method according to claim 1, further comprising adding at least one β-glucosidase-containing composition before maintaining the comestible in a temperature of from about 20° C. to about 70° C., for a period of from about 1 minute to about four hours.

8. The method according to claim 7, wherein the at least one β-glucosidase-containing composition comprises almond.

9. The method according to claim 8, wherein the almond is raw almond.

10. The method according to claim 7, further comprising heating the comestible in a temperature of from about 120° C. to about 260° C., for a period of from about 15 minutes to about 2 hours, after maintaining the comestible in a temperature of from about 22° C. to about 70° C., for a period of from about 30 minutes to about four hours.

11. The method according to claim 10, wherein the heating temperature is from about 150° C. to about 180° C.

12. The method according to claim 11, wherein the heating temperature is about from about 160° C. to about 165° C.

13. The method according to claim 1, further comprising heating the comestible in a temperature of from about 120° C. to about 260° C., for a period of from about 15 minutes to about 2 hours, after maintaining the comestible in a temperature of from about 22° C. to about 70° C., for a period of from about 30 minutes to about four hours.

14. The method according to claim 13, wherein the heating temperature is from about 175° C. to about 225° C.

15. The method according to claim 14, wherein the heating temperature is about from about 190° C. to about 210° C.

16. A comestible having a β-glucosidase activity of greater than or equal to about 35 U when measured by assaying its rate of hydrolysis of p-nitrophenyl-β-D-glucopyranoside at a temperature of 37° C. for 30 minutes at pH 4.6, wherein the comestible comprises less than about 75% by total weight, of almond.

17. The comestible according to claim 16, wherein the β-glucosidase activity is greater than or equal to about 45 U.

18. The comestible according to claim 17, wherein the β-glucosidase activity is greater than or equal to about 50 U.

19. The comestible according to claim 16, wherein the comestible comprises at least about 5% by total weight, of soy-based ingredients.

20. The comestible according to claim 19, wherein the comestible comprises greater than or equal to about 4 g of soy protein per serving.

21. The comestible according to claim 20, wherein the comestible comprises greater than or equal to about 5 g of soy protein per serving.

22. The comestible according to claim 21, wherein the comestible comprises greater than or equal to about 6 g of soy protein per serving.

23. The comestible according to claim 22, wherein the comestible comprises greater than or equal to about 7 g of soy protein per serving.

24. The comestible according to claim 16, wherein the comestible comprises greater than about 300 nmol/g of isoflavone aglycones.

25. The comestible according to claim 24, wherein the comestible comprises greater than about 400 nmol/g of isoflavone aglycones.

26. The comestible according to claim 25, wherein the comestible comprises greater than about 500 nmol/g of isoflavone aglycones.

27. The comestible according to claim 16, wherein the comestible comprises from about 1% to about 15% by total weight, almond.

28. The comestible according to claim 27, wherein the comestible comprises from about 2.5% to about 10% by total weight, almond.

29. The comestible according to claim 28, wherein the comestible comprises from about 5% to about 8% by total weight, almond.

30. A soy bread product comprising greater than or equal to about 6.25 g soy protein per serving, from about 2% to about 10% by total weight, of almond, and greater than or equal to about 200 nmol/g of isoflavone aglycones.

31. The soy bread product according to claim 30, comprising from about 5% to about 8% almond, and greater than or equal to about 400 nmol/g of isoflavone aglycones.

32. The soy bread product according to claim 30, wherein the almond is chosen from chopped almond, ground almond, or almond powder.

33. The soy bread product according to claim 32, wherein the almond exhibits an average particle size of less than 0.1 mm.

34. A soy bread product enriched in isoflavone aglycones, comprising greater than about 2.5%, by total weight, of almond.

35. A method of increasing the isoflavone aglycone concentration in a soy-containing comestible comprising maintaining the comestible in a temperature of from about 45° C. to about 48° C., for a period of from about 1.5 hours to about 2.5 hours, wherein the method results in an increase in isoflavone aglycone concentration.

36. A method of increasing the isoflavone aglycone concentration in a soy-containing comestible comprising:
adding at least one β-glucosidase-containing composition to a soy-containing comestible composition, and
maintaining the comestible in a temperature of from about 45° C. to about 48° C., for a period of from about 1.5 hours to about 2.5 hours,
wherein the method results in an increase in isoflavone aglycone concentration in the comestible.
